(19) United States
(12) Patent Application Publication
(10) Pub. No.: US 2008/0015713 A1
(43) Pub. Date: Jan. 17, 2008

(54) Circuit arrangement and method for controlling at least one actuator in a motor vehicle

(76) Inventor: Axel Pannwitz, Radebeul (DE)

Correspondence Address: MG-IP Law, PLLC, P.O. BOX 1364, FAIRFAX, VA, 22038-1364, US

(21) Appl. No.: 11/819,511

(22) Filed: Jun. 27, 2007

Related U.S. Application Data
(60) Provisional application No. 60/819,385, filed on Jul. 10, 2006.

(30) Foreign Application Priority Data
Jun. 27, 2006 (DE) DE 10 2006 029514

(51) Int. Cl. G05B 11/01

(52) U.S. Cl. 700/8

(57) ABSTRACT

A circuit arrangement is provided for controlling at least one actuator in a motor vehicle, comprising a microcontroller, a watchdog circuit with an active operating mode for monitoring the functionality of the microcontroller and a reduced activity operating mode, and with at least one microcontroller-controlled peripheral unit with a first operating mode for controlling at least one actuator. According to the invention, the peripheral unit has a second operating mode and is designed to change the actuator to a safe mode and/or to keep it in this mode when the peripheral unit is in the second operating mode, and the circuit arrangement is designed to operate the peripheral unit in the second operating mode at least whenever the watchdog circuit is in the reduced activity operating mode. The invention relates furthermore to a corresponding method for controlling at least one actuator in a motor vehicle.

This nonprovisional application claims priority to German Patent Application No. DE 102006029514, which was filed in Germany on Jun. 27, 2006, and to U.S. Provisional Application No. 60/819,385, which was filed on Jul. 10, 2006, and which are both herein incorporated by reference.

### BACKGROUND OF THE INVENTION

1. Field of the Invention

The present invention relates to a circuit arrangement and a method for controlling at least one actuator in a motor vehicle.

2. Description of the Background Art

The invention falls within the field of the control of actuators, such as, e.g., electric motors, electromagnets, and heating wires, which are built in many cases at very different locations into modern motor vehicles. Such actuators, often also called control or positioning elements, are used, for example, to drive windshield wipers or to set headlights, seats, thermostatic valves, throttle valves, turbochargers, etc.

DE 102 55 430 A1 discloses a circuit arrangement for controlling an occupant protection system with a microprocessor, a watchdog circuit, and ignition end stages for actuating airbags, seat belt retractors, etc. The watchdog circuit, in this case, has an active mode for monitoring the microprocessor and an inactive mode in which monitoring of the microprocessor ceases in order to reduce current consumption when the microprocessor is in a sleep mode.

It is a disadvantage here that it is not possible without additional costly measures, e.g., to perform a microprocessor self-test or to receive a new program code for the microprocessor and to store it in a nonvolatile memory, because faulty triggering of the ignition end stages by the microprocessor and thereby an unintentional actuation of airbags, seat belt retractors, etc., are not systematically ruled out. A time- and cost-intensive disassembling of the entire subassembly, often built “deep” into the vehicle, with the circuit arrangement in a repair shop is usually necessary for such testing or download measures.

### SUMMARY OF THE INVENTION

It is therefore an object of the present invention to provide a circuit arrangement, simple and cost-effective to implement, which drives the at least one actuator reliably and safely also when the microcontroller or microprocessor is not in the normal, actuator-controlling operating mode, but, for example, performs a self-test or receives a new program code for improved actuator control. It is furthermore the object of the invention to provide a corresponding method.

The circuit arrangement of the invention for controlling at least one actuator in a motor vehicle comprises (a) a microcontroller, (b) a watchdog circuit with an active operating mode W1 for monitoring microcontroller functionality and a reduced activity operating mode W2, and (c) at least one microcontroller-controlled peripheral unit with a first operating mode P1 for controlling at least one actuator, whereby (d) the peripheral unit has a second operating mode P2 and is designed to change the actuator to a safe mode or (and/or) to keep it in this mode when the peripheral unit is in the second operating mode P2, and (e) the circuit arrangement is designed to operate the peripheral unit in the second operating mode P2 at least whenever the watchdog circuit is in the reduced activity operating mode W2.

The method of the invention for controlling at least one actuator in a motor vehicle with a microcontroller, a watchdog circuit with an active operating mode W1 for monitoring microcontroller functionality and a reduced activity operating mode W2, and with at least one microcontroller-controlled peripheral unit with a first operating mode P1 for controlling at least one actuator, comprises the steps: (a) operation of the peripheral unit in a second operating mode P2 at least whenever the watchdog circuit is in the reduced activity operating mode W2, and (b) changing the actuator to or (and/or) keeping it in a safe mode, when the peripheral unit is in the second operating mode P2.

The essence of the invention is to bring the actuator or actuators into a safe state, i.e., which does not cause any damage, disturbances, malfunctions, or the like, and/or to keep it (them) in such a state when the peripheral unit is in the second operating mode P2, and to operate the peripheral unit in the second operating mode P2 at least whenever the watchdog circuit is in the reduced activity operating mode W2. The “reduced activity” operating mode is taken to mean here that the watchdog circuit in this mode does not monitor the functionality of the microcontroller or it monitors it less precisely in comparison with the active operating mode. The peripheral unit is preferably designed as driver circuit for controlling the actuator or actuators.

The actuator is also advantageously reliably and safely driven by this means when the microcontroller or microprocessor is not in the normal operating mode, in which it drives the actuator, but, e.g., performs a self-test or receives a new program code, without additional elaborate and cost-intensive measures being necessary, such as disassembly of the entire subassembly from the vehicle, or additional fuse switches and/or additional line connections (and thereby additional terminals) from a higher-order control computer to the circuit arrangement or to the actuators having to be provided. Interruption of the actuator voltage supply is also advantageously not necessary.

In an embodiment of the circuit arrangement and the method, the peripheral unit is changed to the second operating mode P2 at the latest when, preferably before, the watchdog circuit is changed to or is in the reduced activity operating mode W2. An especially safe and reliable actuator control is achieved in this way. Changing the peripheral unit to mode P2 before switching of the watchdog circuit makes it possible to take into account the time interval required at most by the actuator to achieve the safe state, so that the actuator reaches the safe state substantially when the watchdog circuit is switched to or is in mode W2.

In another embodiment of the circuit arrangement and the method, the peripheral unit is operated if need be in the first operating mode P1 when the watchdog circuit is in the active operating mode W1. Preferably, the peripheral unit is changed to the first operating mode P1 at the earliest when the watchdog circuit is changed to or is in the active operating mode W1. As a result, the time interval in which the actuator pauses in the safe state and thereby is not available for its actual function is advantageously limited or shortened.

In an embodiment of the circuit arrangement, the microcontroller is designed to change the peripheral unit from the first to the second and/or from the second to the first operating mode. This type of circuit arrangement is simple and cost-effective to implement.

In another embodiment of the circuit arrangement and the method, a new program code for the microcontroller is stored only when the watchdog circuit is in the reduced activity operating mode W2, and/or a microcontroller self-test is performed only when the watchdog circuit is in the reduced activity operating mode W2. In this way, it is advantageously assured that a download of a program code and/or a self-test can be accomplished without the risk of an erroneous driving of the actuator.

In another embodiment of the circuit arrangement and the method, the peripheral unit reacts exclusively to precisely one predefined command when it is in the second operating mode P2, and changes to the first operating mode P1 when it receives the predefined command. Especially safe and reliable actuator control is achieved in this way in which control errors are essentially eliminated.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a vehicle with a circuit arrangement according to an embodiment of the invention;

FIG. 2 illustrates an embodiment of the circuit arrangement of the invention; and

FIG. 3 illustrates an embodiment of a method of the invention.

### DETAILED DESCRIPTION

In the figures, the same and functionally identical elements and signals, if not specified otherwise, are provided with the same reference characters.

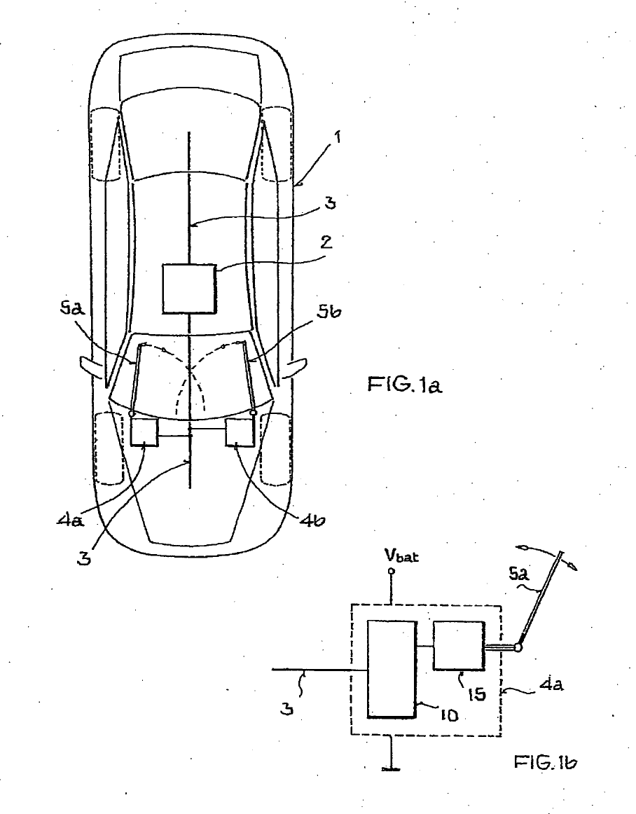

FIG. 1 shows a vehicle with a circuit arrangement of the invention.

According to the top plan view in FIG. 1a, motor vehicle 1 has a central control device 2 with a higher-order control computer which is connected by a serial control bus 3 to a plurality of vehicle components. The vehicle components controlled by the control computer are, for example, the depicted subassemblies (control devices) 4a, 4b for controlling the front windshield wipers 5a, 5b or other subassemblies for controlling headlights, seats, turbochargers, valves, etc., which are built at very different locations into motor vehicle 1. Many of these vehicle components have one or more actuators (also called control or positioning elements), which convert electrical energy into other forms of energy, such as, e.g., kinetic, potential, magnetic, and light energy, sound energy, and/or thermal energy. Thus, an actuator can be, for example, an electric motor, an electromagnet, a heating wire, etc., whereby the actuator is used to drive a windshield wiper, to set a headlight (beam width, curve light), a seat (height, inclination, etc.), a throttle valve, a turbocharger (angle of attack), a thermostatic valve in the cooling water circulation, etc.

Serial control bus 3 is, for example, designed as a LIN bus (local interconnect network) or as a CAN bus (controller area network).

FIG. 1b shows, as an example of one of the aforementioned vehicle components, a block diagram of subassembly 4a for controlling the front windshield wiper 5a of FIG. 1a. Subassembly 4a has an actuator 15 in the form of an electric motor to control (drive) the front windshield wiper 5a and a circuit arrangement 10 of the invention. Circuit arrangement 10 is connected to actuator 15 and by control bus 3 to control computer 2 (FIG. 1a). Furthermore, the subassembly for a power supply to circuit arrangement 10 and actuator 15 is connected by a terminal of the subassembly to the vehicle battery at which the battery voltage Vbat is applied.

Circuit arrangement 10 controls electric motor 15 in such a way that front windshield wiper 5a, on the one hand, removes moisture as efficiently as possible from the front windshield and, on the other, does not touch any other vehicle parts at the windshield edges, such as, e.g., the A pillar. If the two front windshield wipers 5a, 5b are not connected together by a rod, it must be assured in addition that the two front windshield wipers do not touch each other during operation.

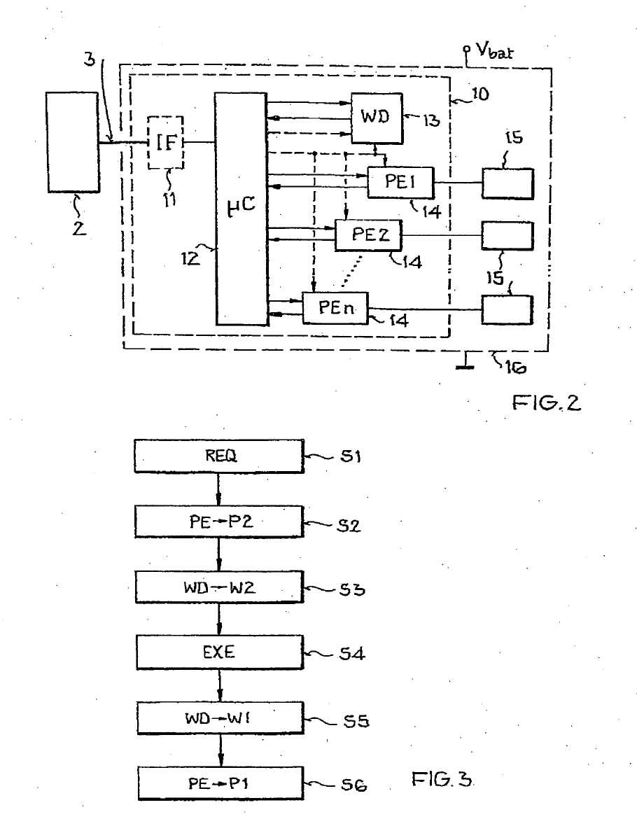

FIG. 2 shows a block diagram of an exemplary embodiment of a circuit arrangement of the invention for controlling at least one actuator. Circuit arrangement 10 has an optional interface (IF) 11, a microcontroller or microprocessor (μC) 12, a watchdog circuit (WD) 13, and a total of n peripheral units (PE1, PE2, . . . , PEn) 14, whereby the number n of peripheral units is at least one (n≧1).

In addition to circuit arrangement 10, a total of m actuators 15 is provided (m≧1) that are assigned to circuit arrangement 10, whereby in the exemplary case in FIG. 2, the number m of actuators 15 coincides with the number n of peripheral units 14 (m=n). The actuators convert the supplied electric energy into other forms of energy, e.g., into kinetic, potential, magnetic, or light energy, sound energy, and/or thermal energy. Preferably, actuators 15 are made as an electric motor, electromagnet, or heating wire and are used particularly for driving windshield wipers or the setting of headlights, seats, thermostatic valves, throttle valves, turbochargers, etc.

Furthermore, preferably, a higher-order control computer 2 of the central control device (see FIG. 1) is provided.

Whereas circuit arrangement 10 is preferably disposed in spatial proximity to at least one actuator 15 assigned to it, circuit arrangement 10 as a rule is not within spatial proximity to the higher-order control computer 2. In an embodiment, circuit arrangement 10 and its actuators 15 are part of one and the same subassembly (control device) 16, which is built into the motor vehicle where the actuator or the actuators are located, i.e., in the vicinity of a windshield wiper motor (see reference characters 4a, 4b in FIG. 1a), headlight motor, seat motor, etc. However, higher-order control computer 2 or the central control device is often located at a central location in the motor vehicle, e.g., in the vehicle tunnel (FIG. 1a).

In the case of the use, described previously with reference to FIG. 1, for controlling the windshield wiper motors, a first subassembly 16 with a first circuit arrangement 10 (having a first peripheral unit) and a first electric motor 15 are disposed in the vicinity of the right front windshield wiper and a second subassembly 16 with a second circuit arrangement 10 (having a second peripheral unit) and a second electric motor 15 in the vicinity of the left front windshield wiper in the motor vehicle.

Microcontroller 12 or interface unit 11 is connected by serial control bus 3 (LIN, CAN bus, etc.) to the higher-order control computer 2. In addition, microcontroller 12 is connected to watchdog circuit 13 and to each of peripheral units 14. Each of the n peripheral units 14 is connected to at least one actuator 15; in the exemplary case of FIG. 2, each peripheral unit is connected to precisely one actuator 15.

Microcontroller 12 controls the other components of circuit arrangement 10, particularly watchdog circuit 13 and peripheral units 14 to control actuators 15. Preferably, microcontroller 12 communicates in addition optionally via interface unit 11 with the higher-order control computer 2, which controls circuit arrangement 10.

Interface unit 11 here serves as a level converter to change voltage values of the serial control bus (LIN, CAN, etc.) into other, e.g., microcontroller-specific voltage values and vice versa. Preferably, interface unit 11 is designed as a short-circuit-proof and overload-proof voltage converter with precisely defined signal-shaping requirements.

Watchdog circuit (WD) 13, which is also called a safety timer unit, has an active operating mode W1 for monitoring the functionality of microcontroller 12 and a reduced activity operating mode W2, in which it does not monitor the functionality of microcontroller 12 or monitors it less precisely in comparison with the active mode W1.

To monitor its functionality, microcontroller 12 at certain time intervals emits so-called trigger pulses to watchdog circuit 13. Watchdog circuit 13 checks whether these trigger pulses meet certain requirements and generates a reset signal for the microcontroller, when the requirements are not met. The requirements for the trigger pulses in this case refer to their presence, number, pulse period, pulse width, etc.

Preferably, watchdog circuit 13 in mode W1 generates a reset signal when the pulse period of the trigger pulse falls below a predefined minimum value or exceeds a predefined maximum value. This type of mode is also called a “window mode.” In mode W2, on the contrary, a reset signal is emitted only when a maximum value is exceeded.

In another embodiment, watchdog circuit 13 in mode W1 generates a reset signal according to the aforementioned window mode, whereas in mode W2 it emits a reset signal when it receives (any) trigger pulses.

In a third embodiment, watchdog circuit 13 in mode W1 generates a reset signal when the pulse period of the trigger pulse exceeds a predefined maximum value whereas in mode W2 it emits a reset signal when it receives (any) trigger pulses.

The switching of watchdog circuit 13 between the operating modes W1 and W2 is controlled by a microcontroller 12, possibly at the instigation of the higher-order control computer 2 and/or upon instigation by a signal applied at another input of the microcontroller. This is illustrated in FIG. 2 by the dashed arrow from microcontroller 12 to watchdog circuit 13.

Each actuator 15 has a “safe” state in which damage, disturbances, or malfunctions are eliminated. In an electric motor for controlling a first front windshield wiper, which is not connected by rods to the second front windshield wiper, this can be, e.g., any windshield wiper position, which rules out contact of the two front windshield wipers and other vehicle parts (A pillar, etc.). For example, this can be a position close to and essentially parallel to the closer A pillar in each case. In the case of an electric motor to set a front headlight, the safe state corresponds, for example, to a normal setting in which the beam direction of the headlight lies in a horizontal plane (normal setting of the beam width) or runs parallel to the longitudinal axis of the vehicle (normal setting of the curve light). In an electromagnet for a thermostatic valve in a cooling water circuit, a safe state is, for example, a completely open state or a state reliably preventing overheating. In the case of a throttle valve, e.g., the closed state represents the safe state, whereas in a turbocharger an angle of attack, which eliminates deterioration of the turbocharger, characterizes the safe state.

Peripheral units 14 are preferably designed as driver circuits for controlling the specifically assigned actuator/actuators 15. Each peripheral unit 14 has a first operating mode P1 and a second operating mode P2. In the first operating mode P1, each peripheral unit 14 converts commands from microcontroller 12 into corresponding control signals to control its actuator or actuators 15. If peripheral unit 14, on the other hand, is in the second operating mode P2, it keeps its actuator(s) 15 in the previously described safe state by generating a control signal, which corresponds to this safe state and then keeps it constant, e.g., so that the state is maintained. Preferably, peripheral unit 14 first changes the actuators to the safe state, when peripheral unit 14 is switched from the first to the second operating mode. Depending on the design of the circuit arrangement and the actuators, this may require the participation of microcontroller 12 in the form of additional commands.

The maintenance of or changing to the safe state is hereby accomplished by the same (control) lines between the peripheral units and the actuators, by which the actuators are also controlled in mode P1 by the peripheral units. Particularly, the changing to or maintaining in a safe state is not achieved by separating the actuators from the power supply.

According to the invention, peripheral units 14 are operated in operating mode P2 at least whenever watchdog circuit 13 is in operating mode W2 and thereby more or less precisely monitors microcontroller 12. Mode P2 is therefore always active when mode W2 is active, but optionally also beyond this, i.e., when the watchdog circuit is in the active operating mode W1.

In operating mode P1, peripheral units 14, if need be, are only operated when the watchdog circuit is in the active operating mode W1. Mode P1 can therefore only be active when mode W1 is also active, but not when W2 is active. On the other hand, P1 need not always be active when W1 is active, so that either P1 or P2 can be active during time intervals in which W1 is active.

Preferably, peripheral units 14 respond exclusively to precisely one predefined command when they are in operating mode P2, and change to operating mode P1 when they receive the predefined command from microcontroller 12.

In an embodiment, microcontroller 12 is designed to change peripheral units 14 from first mode P1 to second mode P2 and/or vice versa. This is shown in FIG. 2 with the use of dashed arrows from microcontroller 12 to peripheral units 14. The mode switching of peripheral units 14 (P1/P2) and watchdog circuit 13 (W1/W2) can occur in this case by means of different signals or the same signals via one or more outputs of the microcontroller.

The switching of peripheral units 14 from mode P1 to mode P2 occurs in time at the latest when watchdog circuit 13 is changed to or is in mode W2. Preferably, peripheral units 14 are switched here before watchdog circuit 13, but at the latest substantially simultaneously with watchdog circuit 13.

After peripheral units 14 are changed to mode P2 and watchdog circuit 13 to mode W2, microcontroller 12 can perform, e.g., a self-test without risk or receive a new program code from higher-order control computer 2 via control bus 3 and store it in a nonvolatile memory, without there being a risk of a control error by the actuators, because these are reliably in a safe state.

The sole danger is that microcontroller 12 erroneously emits the previously discussed predefined command for switching peripheral units 14 back to mode P1, before the download or self-test has been properly completed. To eliminate this danger, the commands of microcontroller 12 for switching peripheral units 14 are preferably transmitted not only to peripheral units 14 but also to watchdog circuit 13, as is shown in FIG. 2 by the dashed arrows from microcontroller 12 to peripheral units 14 and watchdog circuit 13. This gives watchdog circuit 13 the possibility of emitting a reset signal to microcontroller 12, when it receives the predefined command for switching peripheral units 14 back to mode P1, as long as it itself is in mode W2.

The switching of peripheral units 14 back to mode P1 or the actuators to an “unsafe” state is prevented by the reset signal.

The switching back of peripheral units 14 from mode P2 to mode P1 occurs at the earliest when watchdog circuit 13 is changed to or is in mode W1. Preferably, peripheral units 14 are switched here substantially simultaneously with watchdog circuit 13.

In an alternative embodiment, watchdog circuit 13 is designed to change peripheral units 14 from mode P1 to mode P2 and/or vice versa. Here, watchdog circuit 13 is connected to peripheral units 14 (not shown in FIG. 2), whereas the dashed arrows from microcontroller 12 to peripheral units 14 are eliminated. In this case, watchdog circuit 13 receives from microcontroller 12 in addition the commands for switching peripheral units 14, or watchdog circuit 13 generates these itself based on the commands for switching watchdog circuit 13. Microcontroller 12 and/or watchdog circuit 13 here as well assure that the mode switching of peripheral units 14 and watchdog circuit 13 occurs in the previously described logical and time sequence.

The previously described circuit arrangement 10 is advantageously simple and cost-effective to implement. In an advantageous embodiment, watchdog circuit 13, peripheral unit(s) 14, and optionally interface unit 11 are part of an integrated circuit, not shown in FIG. 2, e.g., an ASIC (application specific integrated circuit) or ASSP (application specific standard product), whereas microcontroller 12 is also realized as a separate integrated circuit, which is also not shown. Preferably, circuit arrangements 10 has only one integrated circuit made, e.g., as ASIC or ASSP, which senses the functions of all units 11-14.

FIG. 3 shows a flow diagram of a method according to the invention for controlling at least one actuator in a motor vehicle.

If, for example, for improved control of the actuators, a new program code is to be stored in the microcontroller or a self-test of microcontroller functionality is to be performed, control computer 2 in step S1 optionally transmits an appropriate request (REQ) to microcontroller 12 (also see FIG. 2). Thereupon, preferably the microcontroller in step S2 changes the peripheral unit(s) PE to mode P2, so that the actuators are brought into a safe state. In step S3, which is preferably performed later or substantially simultaneously with step S2, the microcontroller switches the watchdog circuit WD to mode W2. After the watchdog circuit has been switched, the microcontroller in step S4 (EXE) performs a self-test and transmits the test result to control computer 2 or requests the new program code from the control computer, which then writes the code in the nonvolatile memory of the microcontroller. After completion of the self-test or the download of the program code, in step S5 the microcontroller changes the watchdog circuit WD to mode W1 and in step S6, which is preferably performed substantially simultaneously or later, the peripheral unit(s) PE to mode P1, so that the actuators are again driven normally by the microcontroller via the peripheral units, so that, e.g., the windshield wipers can provide their function.

The peripheral units are therefore operated in operating mode P2 at least whenever the watchdog circuit is in the reduced activity operating mode W2 (in FIG. 3 from step S3 to step S4 inclusive), but optionally also in other time intervals (from step S2 and to step S5 inclusive), in which the watchdog circuit is in the normal operating mode W1. In mode P1, the peripheral units are operated if need be when the watchdog circuit is in the active operating mode W1 (before S3 and after S5). It is assured in this way that a download of the new program code or a microcontroller self-test is performed (S4) only when the peripheral unit(s) PE are in mode P2 or the actuators are in a safe state.

In operating mode P2 (S2-S5), the peripheral unit(s) preferably respond(s) exclusively to precisely one predefined command and change(s) to operating mode P1 (S6), when it (they) receive(s) the predefined command. In this way, control errors of the actuators due to undefined commands/signals from the microcontroller, e.g., during the self-test or download are eliminated.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A circuit arrangement for controlling at least one actuator in a motor vehicle, the circuit arrangement comprising:
a microcontroller;
a watchdog circuit having an active operating mode for monitoring a functionality of the microcontroller and having a reduced activity operating mode; and
at least one microcontroller-controlled peripheral unit with a first operating mode for controlling at least one actuator,
wherein the peripheral unit has a second operating mode and is configured to change the actuator to a safe mode and/or to keep the actuator in the safe mode when the peripheral unit is in the second operating mode, and
wherein the circuit arrangement is designed to operate the peripheral unit in the second operating mode at least whenever the watchdog circuit is in the reduced activity operating mode.

2. The circuit arrangement according to claim 1, wherein the circuit arrangement is designed such that the peripheral unit changes to the second operating mode at the latest when the watchdog circuit is changed to the reduced activity operating mode.

3. The circuit arrangement according to claim 1, wherein the circuit arrangement is designed to operate the peripheral unit in the first operating mode, if need be, when the watchdog circuit is in the active operating mode.

4. The circuit arrangement according to claim 1, wherein the circuit arrangement is designed to change the peripheral unit to the first operating mode, at the earliest, when the watchdog circuit is changed to the active operating mode.

5. The circuit arrangement according to claim 1, wherein the microcontroller is designed to change the peripheral unit from the first operating mode to the second operating mode and/or from the second operating mode to the first operating mode.

6. The circuit arrangement according to claim 1, wherein the watchdog circuit is designed to change the peripheral unit from the first operating mode to the second operating mode and/or from the second operating mode to the first operating mode.

7. The circuit arrangement according to claim 1, wherein the microcontroller is designed to change the watchdog circuit from the active operating mode to the reduced activity operating mode and vice versa.

8. The circuit arrangement according to claim 1, wherein the microcontroller is designed to change the watchdog circuit upon instigation by a higher-order control computer from the active operating mode to the reduced activity operating mode.

9. The circuit arrangement according to claim 1, wherein the microcontroller is connected via a serial control bus, particularly a LIN or CAN bus, to a higher-order control computer.

10. The circuit arrangement according to claim 8, wherein the microcontroller is provided in a motor vehicle, but not in spatial proximity to the higher-order control computer.

11. The circuit arrangement according to claim 10, wherein the microcontroller is provided in spatial proximity to an actuator.

12. The circuit arrangement according to claim 1, wherein the microcontroller is designed to store a new program code only when the watchdog circuit is in the reduced activity operating mode, and/or designed to perform a self-test only when the watchdog circuit is in the reduced activity operating mode.

13. The circuit arrangement according to any claim 1, wherein the watchdog circuit is designed not to monitor the functionality of the microcontroller in the reduced activity operating mode or to monitor it less precisely in comparison with the active operating mode.

14. The circuit arrangement according to claim 1, wherein the peripheral unit is designed to respond exclusively to precisely one predefined command, when it is in the second operating mode and to change to the first operating mode when it receives the predefined command.

15. The circuit arrangement according to claim 1, wherein the peripheral unit is designed as a driver circuit for controlling the actuator.

16. The circuit arrangement according to claim 1, wherein the actuator is designed as an electric motor, electromagnet, or heating wire.

17. The circuit arrangement according to claim 1, wherein the actuator is arranged to cause no damage, disturbances, or malfunctions in the safe state.

18. A method for controlling at least one actuator in a motor vehicle having a microcontroller, a watchdog circuit with an active operating mode for monitoring the functionality of the microcontroller and a reduced activity operating mode, and having at least one microcontroller-controlled peripheral unit with a first operating mode for controlling at least one actuator, the method comprising:
operating the peripheral unit in a second operating mode at least whenever the watchdog circuit is in the reduced activity operating mode; and
changing the actuator to and/or keeping the actuator in a safe mode, when the peripheral unit is in the second operating mode.

19. Method according to claim 18, wherein the peripheral unit is changed to the second operating mode at the latest when the watchdog circuit is changed to the reduced activity operating mode.

20. The method according to claim 19, wherein the peripheral unit is changed to the second operating mode before the watchdog circuit is changed to the reduced activity operating mode.

21. The method according to claim 18, wherein the peripheral unit is operated in the first operating mode, if need be, when the watchdog circuit is in the active operating mode.

22. The method according to claim 18, wherein the peripheral unit is changed to the first operating mode, at the earliest, when the watchdog circuit is changed to the active operating mode.

23. The method according to claim 22, wherein the peripheral unit is changed to the first operating mode substantially when the watchdog circuit is changed to the active operating mode.

24. The method according to claim 18, wherein a new program code for the microcontroller is stored only when the watchdog circuit is in the reduced activity operating mode, and/or a microcontroller self-test is performed only when the watchdog circuit is in the reduced activity operating mode.

25. The method according to claim 18, wherein the peripheral unit reacts exclusively to precisely one predefined command when it is in the second operating mode, and changes to the first operating mode when it receives the predefined command.
